(19) United States
(12) Patent Application Publication
(10) Pub. No.: US 2025/0323422 A1
(43) Pub. Date: Oct. 16, 2025

(54) INTEGRATED RADIO FREQUENCY ANTENNA COMPONENT, RADIO FREQUENCY MODULE AND A WIRELESS MOBILE DEVICE

(71) Applicant: Skyworks Solutions, Inc., Irvine, CA (US)

(72) Inventor: René Rodríguez, Rancho Santa Margarita, CA (US)

(21) Appl. No.: 19/174,755

(22) Filed: Apr. 9, 2025

Related U.S. Application Data
(60) Provisional application No. 63/633,355, filed on Apr. 12, 2024.

(51) Int. Cl. H01Q 9/16; H01Q 1/24; H01Q 1/48

(52) U.S. Cl. CPC H01Q 9/16; H01Q 1/243; H01Q 1/48

(57) ABSTRACT

An radio frequency antenna includes a substrate having a first surface and a second surface opposite the first surface, an I/O port configured to transmit and receive radio frequency signals, and a first radiator structure defined by a conductive material coupled to the first surface. The first radiator structure includes an elongated main antenna portion connected to the I/O port and having an antenna length of one-quarter wavelength of an electromagnetic wave under a resonance frequency, at least one first antenna crossing portion that intersects the elongated main antenna portion at a first intersection node, and at least one second antenna crossing portion that intersects the at least one first antenna crossing portion at a second intersection node. A ground plane is coupled to the second surface and to the first radiator structure, the ground plane having attached thereto a mirror image of the first radiator structure. The first radiator structure and mirror image form a dipole antenna.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

The present invention relates to an integrated radio frequency, RF, antenna component for transmitting and receiving RF signals. The present invention further relates to a RF module and a wireless mobile device.

The modern trend of the antenna component design in the wireless mobile device emphasizes achieving higher gain, greater efficiency, wider bandwidth, and more compact design. Patch antennas and inverted F-antennas are frequently used in wireless communication devices due to their properties such as high gain, lightweight construction, compact design, and cost-effectiveness.

A patch antenna is a type of antenna with a low profile, which can be mounted on a surface of a substrate. It typically consists of a planar rectangular, circular, triangular, or any geometrical sheet or “patch” of metal, mounted over a larger sheet of metal called a ground plane.

An inverted-F antenna, or shortly IFA, is a type of antenna that is used in wireless communication, mainly at ultra-high-frequency, UHF, and RF frequencies. It consists of a monopole antenna running parallel to a ground plane and grounded at one end. The inverted-F antenna is fed from an intermediate point a distance from the grounded end. Further, printed inverted F-antennas, PIFA, are also popular in the antenna component design. For the reason that the inverted F-antennas are printed on printed circuit board, PCB, this saves space on the assembly circuit board.

However, conventional patch antennas often require modifications such as cutting slots or adjusting substrate thickness to enhance antenna performance, such as harmonics suppression and bandwidth improvement, while PIFAs may involve meandering lines and shorting strips to improve both efficiency and bandwidth.

Such conventional antenna modifications are faced with several technical challenges: For example, the patch antenna component becomes less compact due to a thicker substrate. Additionally, the manufacturing process for cutting slots or introducing meandering lines in antenna components is time-consuming and as such is expensive.

### SUMMARY OF THE INVENTION

In some aspects, the techniques described herein relate to an integrated radio frequency antenna component including: a substrate having a first surface and a second surface opposite the first surface; an I/O port configured to transmit and receive radio frequency signals; a first radiator structure defined by a conductive material coupled to the first surface and including an elongated main antenna portion connected to the I/O port and having an antenna length of one-quarter wavelength of an electromagnetic wave under a resonance frequency, at least one first antenna crossing portion that intersects the elongated main antenna portion at a first intersection node, and at least one second antenna crossing portion that intersects the at least one first antenna crossing portion at a second intersection node; and a ground plane coupled to the second surface and to the first radiator structure, the ground plane having attached thereto a mirror image of the first radiator structure, the first radiator structure and the mirror image forming a dipole antenna.

In some aspects, the techniques described herein relate to an integrated radio frequency antenna component wherein the first radiator structure has a #-like shape.

In some aspects, the techniques described herein relate to an integrated radio frequency antenna component wherein the first radiator structure includes a feed line portion connected to the I/O port and an antenna portion connected to the feed line portion wherein the antenna portion includes the #-like shape.

In some aspects, the techniques described herein relate to an integrated radio frequency antenna component wherein the first radiator structure is at least partially embedded in the substrate.

In some aspects, the techniques described herein relate to an integrated radio frequency antenna component wherein the elongated main antenna portion includes at least one inflection point between the I/O port and an open end of the elongated main antenna portion.

In some aspects, the techniques described herein relate to an integrated radio frequency antenna component wherein the at least one first antenna crossing portion intersects the elongated main antenna portion in an oblique manner.

In some aspects, the techniques described herein relate to an integrated radio frequency antenna component wherein the at least one first antenna crossing portion intersects the elongated main antenna portion in a perpendicular manner.

In some aspects, the techniques described herein relate to an integrated radio frequency antenna component wherein the at least one second antenna crossing portion intersects the at least one first antenna crossing portion in an oblique manner.

In some aspects, the techniques described herein relate to an integrated radio frequency antenna component wherein the at least one second antenna crossing portion intersects the at least one first antenna crossing portion in a perpendicular manner.

In some aspects, the techniques described herein relate to an integrated radio frequency antenna component wherein the first radiator structure has a #-like shape, and an angle between the at least one first antenna crossing portion and the elongated main antenna portion at the first intersection node is the same as an angle between the at least one second antenna crossing portion and the at least one first antenna crossing portion at the second intersection node.

In some aspects, the techniques described herein relate to an integrated radio frequency antenna component further including a matching network which is connected to the I/O port and which is configured to conduct impedance transformation to maximize power transfer at an operating frequency range.

In some aspects, the techniques described herein relate to an integrated radio frequency antenna component wherein the substrate consists of an electrically isolating substrate material.

In some aspects, the techniques described herein relate to a radio frequency module including: a printed circuit board; a radio frequency antenna component arranged on the printed circuit board and including: a substrate having a first surface and a second surface opposite the first surface; and a first radiator structure defined by a conductive material coupled to the first surface and including an elongated main antenna portion and having an antenna length of one-quarter wavelength of an electromagnetic wave under a resonance frequency, at least one first antenna crossing portion that intersects the elongated main antenna portion at a first intersection node, and at least one second antenna crossing portion that intersects the at least one first antenna crossing portion at a second intersection node; and a ground plane coupled to the second surface and to the first radiator structure, the ground plane having attached thereto a mirror image of the first radiator structure, the first radiator structure and the mirror image forming a dipole antenna.

In some aspects, the techniques described herein relate to a radio frequency module wherein the first radiator structure has a #-like shape.

In some aspects, the techniques described herein relate to a radio frequency module wherein the first radiator structure includes a feed line portion connected to an I/O port of the radio frequency antenna component, and an antenna portion connected to the feed line portion wherein the antenna portion includes the #-like shape.

In some aspects, the techniques described herein relate to a radio frequency module wherein the elongated main antenna portion includes at least one inflection point between the I/O port and an open end of the elongated main antenna portion.

In some aspects, the techniques described herein relate to a radio frequency module wherein the first radiator structure is at least partially embedded in the substrate.

In some aspects, the techniques described herein relate to a radio frequency module wherein the at least one first antenna crossing portion intersects the elongated main antenna portion in an oblique manner.

In some aspects, the techniques described herein relate to a wireless mobile device including: a housing; a processing device; and a radio frequency module arranged in the housing, the radio frequency module including a radio frequency antenna component including: a substrate having a first surface and a second surface opposite the first surface; and a first radiator structure defined by a conductive material coupled to the first surface and including an elongated main antenna portion and having an antenna length of one-quarter wavelength of an electromagnetic wave under a resonance frequency, at least one first antenna crossing portion that intersects the elongated main antenna portion at a first intersection node, and at least one second antenna crossing portion that intersects the at least one first antenna crossing portion at a second intersection node; and a ground plane coupled to the second surface and to the first radiator structure, the ground plane having attached thereto a mirror image of the first radiator structure, the first radiator structure and the mirror image forming a dipole antenna.

In some aspects, the techniques described herein relate to a wireless mobile device further including at least one screen arranged in the housing.

In some aspects, the techniques described herein relate to a wireless mobile device wherein the processing device includes at least one of a central processing unit (CPU), a memory, and a motherboard.

According to a first aspect, the present disclosure provides an integrated RF antenna component, the RF antenna component comprising: a substrate; at least one I/O port which is configured to transmit and receive RF signals; at least one first radiator structure defined by the shape of a conductive material that is coupled to the substrate, wherein the radiator structure comprises: an elongated main antenna portion connected to the I/O port and having an antenna length of one-quarter wavelength of the electromagnetic wave under the resonance frequency, which antenna length is defined by the length of the main antenna portion from the I/O port to an open end of the main antenna portion; at least one first antenna crossing portion which is intersecting the elongated main antenna portion at a first intersection node; and at least one second antenna crossing portion which is intersecting the first antenna portion at a second intersection node.

According to a second aspect, the present disclosure provides an A RF module, the RF module comprising: a printed circuit board, PCB; at least one integrated RF antenna component arranged to the PCB, the integrated RF antenna component comprises: a substrate; at least one I/O port which is configured to transmit and receive RF signals; at least one first radiator structure defined by the shape of a conductive material that is coupled to the substrate, wherein the radiator structure comprises: an elongated main antenna portion connected to the I/O port and having an antenna length of one-quarter wavelength of the electromagnetic wave under the resonance frequency, which antenna length is defined by the length of the main antenna portion from the I/O port to an open end of the main antenna portion; at least one first antenna crossing portion which is intersecting the elongated main antenna portion at a first intersection node; and at least one second antenna crossing portion which is intersecting the first antenna crossing portion at a second intersection node.

According to a third aspect, the present disclosure provides a wireless mobile device, wherein the wireless mobile device comprising: a housing; at least one processing device which is configured to process the information within the wireless mobile device; and a RF module arranged in the housing, the RF module comprising at least one integrated RF antenna component arranged to a PCB, wherein an integrated RF antenna structure comprising a substrate having a first surface arranged with a conductive material, and at least one first radiator structure defined by the shape of the conductive material, wherein the first radiator structure comprises: an elongated main antenna portion connected to the I/O port and having an antenna length of one-quarter wavelength of the electromagnetic wave under the resonance frequency, which antenna length is defined by the length of the main antenna portion from the I/O port to an open end of the main antenna portion; at least one first antenna crossing portion which is intersecting the elongated main antenna portion at a first intersection node; and at least one second antenna crossing portion which is intersecting the first antenna crossing portion at a second intersection node.

The present invention is based on the idea to provide an as well compact and at the same time flexible design of an integrated RF antenna component. It is the use of an elongated main antenna portion having one-quarter wavelength of the electromagnetic wave under the resonance frequency that provides the core operating resonance frequency. The antenna length of the elongated main antenna portion needs to be enlarged or reduced when another resonant operating frequency is required, as long as the length of the elongated main antenna portion is equal to or nearly equal to one-quarter wavelength of the electromagnetic wave under the resonance frequency. It is the use of the at least one first crossing antenna portion which is intersecting the elongated main antenna portion and/or at least one second antenna crossing portion which is intersecting the first crossing antenna portion to provide the realization of the improved, upgraded wideband and harmonic suppression and other improved antenna radiation performance.

The present invention is not limited to abrupt changes in the surface current of the patch in patch antenna design caused by engraving slots in a circular or square patch, which typically leads to high current densities at the corners of the slots. High current densities at the corners of the slots are often the source of high-frequency harmonics and reduced antenna radiation efficiency and usually the patch antenna design needs additional refinement to compensate the negative effect caused by approaches aimed at addressing narrow bandwidth.

Additionally, a thorough examination of the surface current distribution of the patch is necessary to accurately determine where to introduce slots. Consequently, when operating at various resonance frequencies, which is typical in modern communication systems and devices, it becomes necessary to reexamine the updated surface current distribution pattern to locate the ideal positions for slots. This constraint on antenna design flexibility extends the design process.

The present invention is also based on the finding that with devices having conventional PIFAs, narrow bandwidth can also be a concern. This issue may require the implementation of meandering lines and shorting strips to enhance both radiation efficiency and bandwidth. The design of meandering lines and shorting strips lacks a definitive pattern, often necessitating numerous tests and checks before effectively addressing this issue. The present invention adopts the crossing antenna portions to address the issue of narrow bandwidth and efficiency improvement. The intersecting antenna portions offer simplicity and flexibility, making them suitable for forming a distinct design pattern.

Advantageous configurations and developments emerge from the further dependent claims and from the description with reference to the figures of the drawings.

In a possible configuration of the integrated RF antenna component, the first antenna structure has a #-like shape. Such #sign may also be denoted as an octothorpe sign, a hash sign, a hashtag sign, a pound sign and/or a number sign. Other antenna structure designs with crossing antenna portions, however, a first antenna structure with a #-like shape does not necessarily possess four intersections, and it is possible for the first antenna structure to possess only two or three intersections.

In a possible configuration of the integrated RF antenna component, the first radiator structure comprises a feed line portion directly connected or coupled to the I/O port and an antenna portion directly connected or coupled to the feed line portion. The antenna portion comprises the #-like shape. The feed line portion of the first radiator structure is preferably electrically coupled to the ground plane.

In a possible configuration of the integrated RF antenna component, the first radiator structure is directly attached to a first surface of the substrate. Alternatively, a support element, support plate, support component, support layer and the like may be arranged between the first radiator structure and the first surface of the substrate. The support element may comprise certain copper pillars, solder balls, solder bumps and the like. The support plate may incorporate glass, ceramic, and/or other filler materials for improved electrical and mechanical stability of the integrated RF antenna component.

In an alternative configuration of the integrated RF antenna component, the first radiator structure is at least partially embedded in the substrate. The first radiator structure can be partially embedded in the substrate which means that parts of the radiator structure are not covered by the substrate and as such are exposed. The first radiator structure may also completely embedded in the substrate and thus covered by the substrate. In this case, the radiator structure is mechanically protected by substrate. For instance, if the first radiator structure is not fully embedded in the substrate, a portion of it must be exposed. This leads to an abrupt change in relative permittivity around the first radiator structure which results in an inhomogeneous electromagnetic field. The substrate can possess multi-layer structure and the materials of different layers may be different. Different substrate materials may contribute to better radiation patterns of the first radiator structure and provide improved thermal conductivity performance. In cases where the first radiator structure is completely embedded in the substrate, the first radiator structure may be covered between the power layer that provide the power for the antenna structure or ground layer that provide the reference potential for the antenna structure, making impedance control easier and providing better shielding.

In a possible embodiment of the integrated RF antenna component, the elongated main antenna portion comprises at least one inflection point between the I/O port and the open end of the main antenna portion. By using at least one inflection point, the elongated main antenna portion is not extending straight, but is changing the direction at the inflection point. This way, by providing a specific knick angle at the inflection point a specific design of the elongated main antenna portion may be provided. The knick angle of the elongated main antenna portion can be a right angle, an acute angle or an obtuse angle. By providing one or more inflection points, more compact, space-saving antenna structures may be provided. Another purpose is to ensure that sufficient space is available on the substrate for the #-shape antenna.

In a possible configuration of the integrated RF antenna component, the first antenna crossing portion intersects the elongated main antenna portion in an oblique manner or in a not perpendicular. The intersection of the first antenna crossing portion and the elongated main antenna portion produces two pairs of identical angles that are opposite to each other, which one pair of the angles have smaller angles less than 90 degree and the another pair of angles have larger angles greater than 90 degree. A greater disparity between the angles of these two pairs of opposite angles results in a more compact antenna design.

In a possible embodiment of the integrated RF antenna component, the first antenna crossing portion intersects the elongated main antenna portion in a perpendicular manner. The intersection of the first antenna crossing portion and the elongated main antenna portion produces an intersection point and four angles with this intersection point as a vertex. In this possible embodiment, all angles formed by this intersection point as a vertex are right angles. This is the less compact option of this antenna portion design, but possibly leads to better transmission and reception characteristics for the antenna performance.

In a possible configuration of the integrated RF antenna component, the second crossing antenna portion intersects the first crossing antenna portion in an oblique manner or in a not perpendicular. The intersection of the second crossing antenna portion and the first crossing antenna portion produces two pairs of identical angles that are opposite to each other, which one pair of the angles have smaller angles less than 90 degree and the another pair of angles have larger angles greater than 90 degree. The compactness of the antenna design is primarily determined by the intersection of the first crossing antenna portion and the elongated main antenna portion, rather than the intersection of the second crossing antenna portion and the first crossing antenna portion.

In a possible configuration of the integrated RF antenna component, the second crossing antenna portion intersects the first antenna portion in a perpendicular manner. The intersection of the second crossing antenna portion and the first crossing antenna portion produces an intersection point and four angles with this intersection point as a vertex. In this possible embodiment, all angles formed by this intersection point as a vertex are right angles. This is the most extended position of this antenna portion design. The compactness of the antenna design is primarily determined by the intersection of the first crossing antenna portion and the elongated main antenna portion, rather than the intersection of the second crossing antenna portion and the first crossing antenna portion.

In a possible configuration of the integrated RF antenna component, the first antenna structure has a #-like shape means that the respective angles at the different intersecting points are the same.

In a possible configuration of the integrated RF antenna component, the first radiator structure is connected to the ground plane with a short end. The short end introduces inductance to compensate the capacitive effect resulting from the coupling between the first radiator structure and the ground plane. This approach enables both compact design and impedance matching simultaneously without placing the additional matching networks outside the substrate.

In a possible configuration, the integrated RF antenna component further comprises a ground plane coupled to the first radiator structure. The ground plane is configured to provide a reference potential of the integrated RF antenna structure and a mirror image of the first radiator structure. The first radiator structure and the mirror image of the first radiator structure defines a second radiator structure. The first radiator structure is directly attached to the first surface of the substrate. The ground plane with the mirror image of the first radiator structure is directly attached to the second surface of the substrate opposite to its first surface. The first radiator structure is electrically coupled to the ground plane with the mirror image of the first radiator structure. Therefore, the first radiator structure and the ground plane with the mirror image of the first radiator structure form a second radiator structure which gives the complete integrated RF antenna component, a dipole antenna structure.

In a possible configuration of the integrated RF antenna component, the integrated RF antenna component comprises a matching network which is connected to the I/O port and which is configured to conduct impedance transformation to maximize power transfer at an operating frequency range. An additional matching network outside the substrate is preferable for situations where the integrated RF antenna component operates at relatively low resonance frequencies, such as around 1.5 GHz or below. Designing a microstrip or stripline compact matching solution becomes more challenging due to the increased microstrip or stripline length required for impedance matching.

In a possible configuration of the integrated RF antenna component, the I/O port comprises a transmit path and a receive path. The transmit path is configured to forward RF transmit signals to the at least one radiator structure. The receive path is configured to forward RF transmit signals received from the at least one radiator structure to a connected circuitry. For instance, in a control command to transmit RF signals via an output terminal, the RF signals are configured to carry particular information processed by a processing unit e.g. through modulation, filtering and/or amplification. The switching network of the RF component selects the transmitting paths and the transmitting antenna components, which are prepared for the signal transmission. In the scenario of receiving RF signals, the control command is adjusted to receive RF signals. The switching network of the RF component then selects the receiving paths and the receiving antenna components, which are ready to receive RF signals. Subsequently, the received RF signals are forwarded to the processing unit which is employing further processing on the forwarded RF signals, e.g. through demodulation, filtering, and/or amplification. Upon demodulation, the useful information and the carried RF waves can be separated, ensuring the success of the communication process.

In a possible configuration of the integrated RF antenna component, the substrate is made of an electrically isolating substrate material. For example, the substrate material may be FR-4 having a dielectric constant of 4.3. FR-4 is an epoxy laminate material that composed of woven fiberglass cloth with an epoxy resin binder that is flame resistant. The designed radiator structure exhibits additional advantages like good isolation, low profile, easy of fabrication and good isolation. The selection of different substrate materials, such as Duroid, Rogers 5880, and Teflon, will be based on their impact on radiation characteristics, such as return loss, gain, and voltage standing wave ratio, VSWR.

In a possible configuration of the integrated RF antenna component, additionally or alternatively, the conductive material consists of or at least comprises copper, aluminum, silver or any alloy thereof. In principle, the efficiency is closely linked to the conductivity of the material: the higher the conductivity, the higher is the efficiency of the antenna. Therefore, it is important to choose such antenna materials, which offer very good conductivity in practice. Other consideration such as mechanical considerations (such as sustainability and mechanical/scratch stability), environmental considerations, cost considerations and weight considerations also play an indispensable role in antenna design. For example, copper, brass (copper-zinc alloy), bronze (copper-tin alloy) and aluminum are among widely used conducting materials to build antennas. Silver is also commonly used in antenna design due to its excellent electrical conductivity. Due to its cost, durability issues, and mechanical strength limitations, one potential solution to manufacture antennas is using a conductive layer composed of prepared silver nanoparticles.

In a possible configuration of the integrated RF antenna component, the elongated main antenna portion and/or the crossing antenna portions have a strip-like shape. “strip-like” in this context means that the length of the corresponding strip is significantly larger than their width. “strip-like” may also mean that the width is more or less constant along the longitudinal extension of the strip of the elongated main antenna portion. The width of the strips also has certain effects on the antenna characteristics: For example, as the width of the strip increases, the characteristic impedance of the strip-like antenna portion decreases. Additionally, certain reflections and parasitic parameters are generated at the inflection points due to abrupt changes in the characteristic impedance of the strip-like antenna portions. Often, some suitable adjustments of the width of the strip-like antenna portions at the inflection point will improve the performance of the antenna. With regard to the cross-section, the strip-like antenna portion typically consists of a comparably thin conductive strip, which means that the thickness of the strip is much lower than its width.

In a possible configuration of the RF module, the integrated RF antenna array is a multiple input multiple output, MIMO, system. The integrated RF antenna components may be composed from either at least one one-dimensional, two-dimensional or three-dimensional antenna arrays that contains a number of RF antenna components which are connected or interconnected with each other. The antenna gain is increasing with the addition of other RF antenna components. For example, the implementation of a MIMO system may be a 2×2 MIMO system, which means it comprises an array of 2×2 RF antenna components. The implemented architecture can be easily scaled to 4×4 system, which means it comprises an array of 4×4 RF antenna components. The 4×4 system may also be composed of four 2×2 MIMO systems. For example, the 1×8 antenna array can be integrated along the edge of a wireless mobile device, enabling beamforming at various angles to deliver usable beams along the edges of devices. Three-dimensional antenna arrays, such as a 4×2×4 configuration or a 4×4×4 antenna configuration, exhibit improved performances when employing joint beamforming techniques. This technique enables the simultaneous achievement of array gain and spatial diversity or multiplexing gain.

In a possible embodiment, the PCB of the RF module can comprise a transceiver, a logic control network, a switching network and a purity of signal processor components. The transceiver is configured to transmit or receive the RF signals. The logic control network is configured to release of logical control commands to the RF module. The switching networking is configured to select a distinctive signal transmitting path to realize half-duplex or full-duplex communication. A purity of signal processor components may comprise low noise amplifiers, LNAs, bypass filters and power amplifiers. The RF module can be a front end module. This RF front end module may include a bypass path. The switch can be configured to electrically connect the low noise amplifier and the integrated antenna component in a first state, and to electrically connect the bypass path and the integrated antenna component in a second state. The RF front end module can further include a power amplifier. The switch can be configured to electrically connect the power amplifier and the integrated antenna component in a third state. In certain applications, the low noise amplifier and the power amplifier circuit are embodied on a single die. The die can be a semiconductor-on-insulator die.

In a possible configuration of the wireless mobile device, the wireless mobile device may comprise at least one central processing unit, CPU, a memory, a motherboard and/or at least one screen attached to or at least partially embedded in the housing of the wireless mobile device. The screen can be a touch screen. The wireless mobile devices can be implemented in or part of various electronic devices: Examples of the electronic devices can include, but not limited to, consumer electronic products, electronic test equipment, cellular communications infrastructure such as a base station, etc. Examples of the electronic devices can include, but not limited to, a mobile phone such as a smart phone, a wearable computing device such as a smart watch or an ear piece, a telephone, a television, a computer monitor, a computer, a modem, a hand-held computer, a laptop computer, a table computer, a personal digital assistant, a microwave, a refrigerator, a vehicular electronic system such as an automotive electronics system, a stereo system, a DVD player, a CD player, a digital music player such as an MP3 player, a radio, a camcorder, a camera such as a digital camera, a portable memory chip, a washer, a dryer, a washer/dryer, peripheral devices, a clock, etc. Further, the electronic devices can include unfinished products.

In a possible configuration of the wireless mobile device, the wireless mobile device is a device operating in a so-called internet of things (IoT) network or smart home network. Additionally, the wireless mobile device can be configured to transmit and/or receive RF signals associated with a Wireless Personal Area Network, WPAN, standard. The wireless mobile device can be configured to transmit and/or receive RF signals associated with a Bluetooth standard. The wireless mobile device can be configured to transmit and/or receive RF signals associated with a ZigBee standard.

In a possible embodiment, the wireless mobile device is a global navigation satellite system, GNSS, device. Preferably, the GNSS device is operable based on the commonly known global positioning standard, GPS. However, it is also possible that the GNSS device is operating based on other positioning standards, such as GLONASS, Galileo and/or BeiDou navigation satellite system.

Where appropriate, the above-mentioned configurations and developments can be combined with each other as desired, as far as this is reasonable. Further possible configurations, developments and implementations of the invention also include combinations, which are not explicitly mentioned, of features of the invention which have been described previously or are described in the following with reference to the embodiments. In particular, in this case, a person skilled in the art will also assess individual aspects as improvements or supplements to the basic form of the present invention.

### BRIEF DESCRIPTION OF THE EMBODIMENTS

For a more comprehensive understanding of the invention and the advantages thereof, exemplary embodiments of the invention are explained in more detail in the following description with reference to the accompanying drawing figures, in which like reference characters designate like parts and in which:

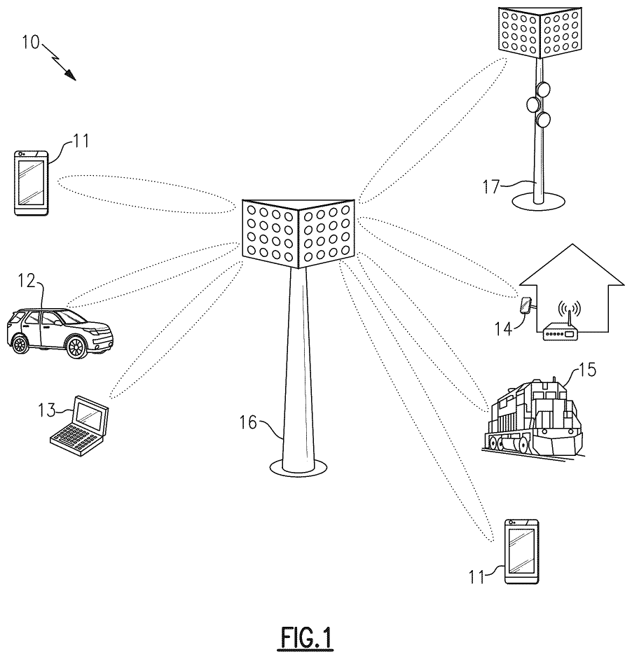

FIG. 1 illustrates a schematic diagram of an example of a communication network;

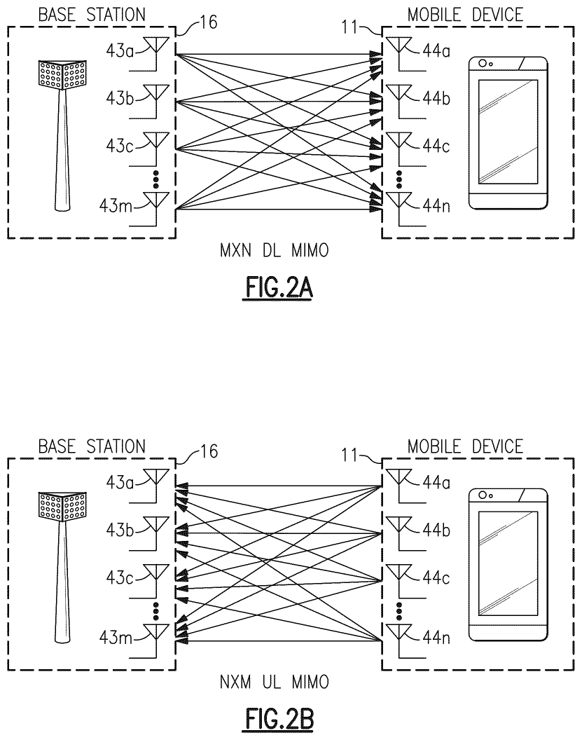

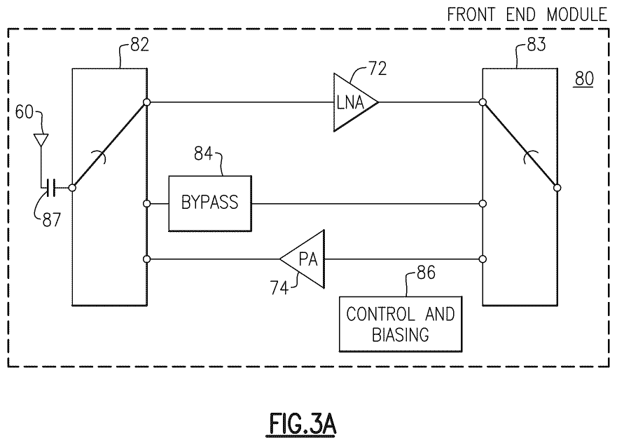

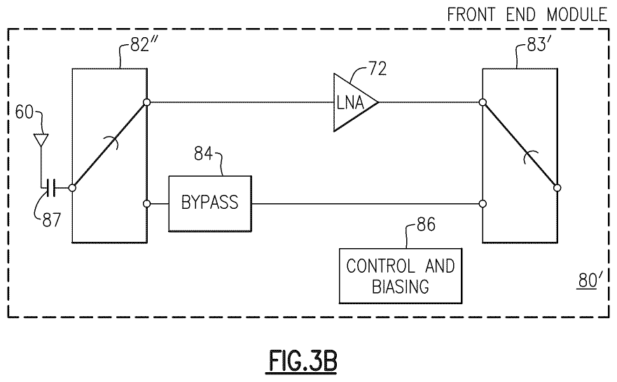

FIG. 2A illustrates a schematic diagram of an example of a downlink channel using multi-input and multi-output, MIMO, communication;

FIG. 2B illustrates a schematic diagram of an example of an uplink channel using MIMO communication;

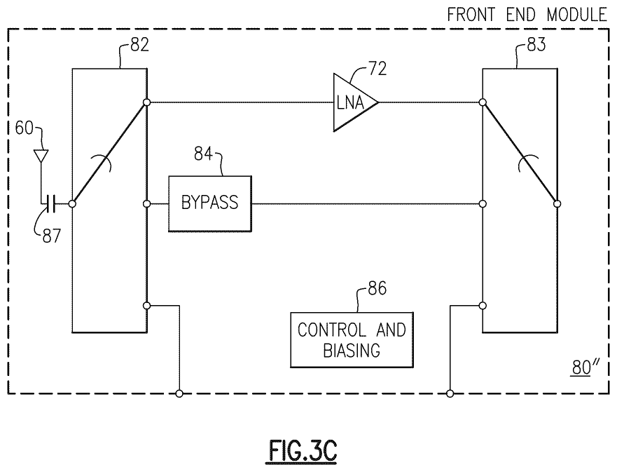

FIG. 3A illustrates a schematic block diagram of a front end module;

FIG. 3B illustrates a schematic block diagram of another front end module;

FIG. 3C illustrates a schematic block diagram of another front end module;

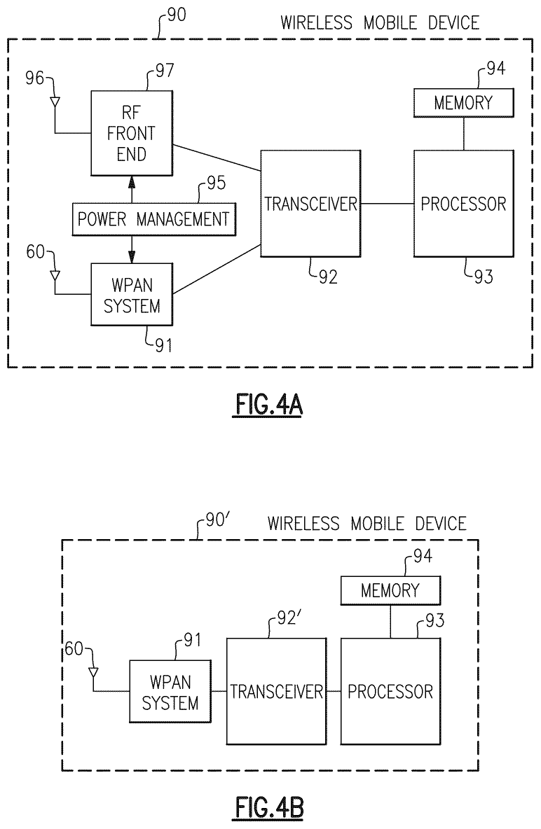

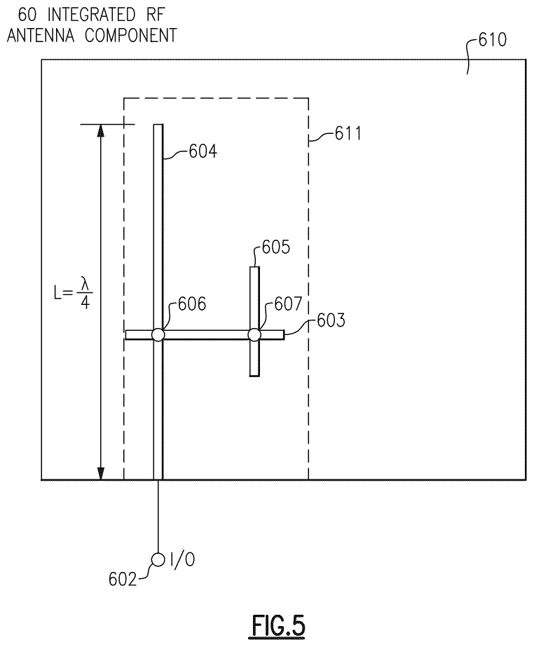

FIG. 4A illustrates a schematic block diagram of a wireless mobile device that includes an integrated RF antenna component in accordance to an aspect of the present invention;

FIG. 4B illustrates a schematic block diagram of another wireless mobile device that includes an integrated antenna in accordance to an aspect of the present invention;

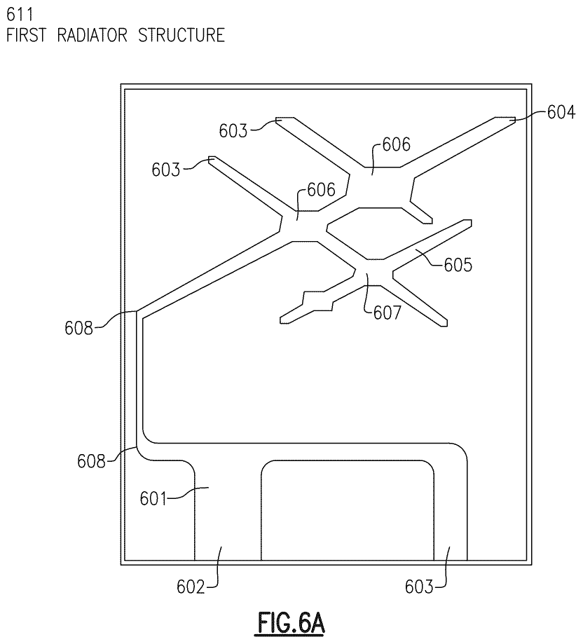

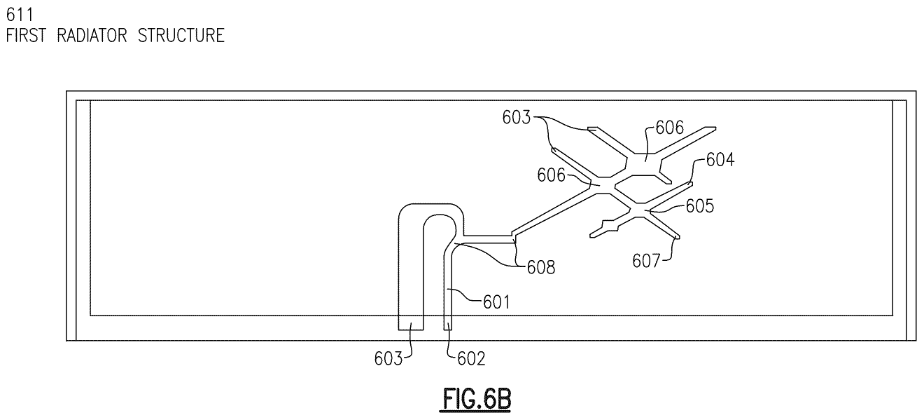

FIG. 5 illustrates a schematic block diagram of an integrated RF antenna component in accordance to an aspect of the present invention;

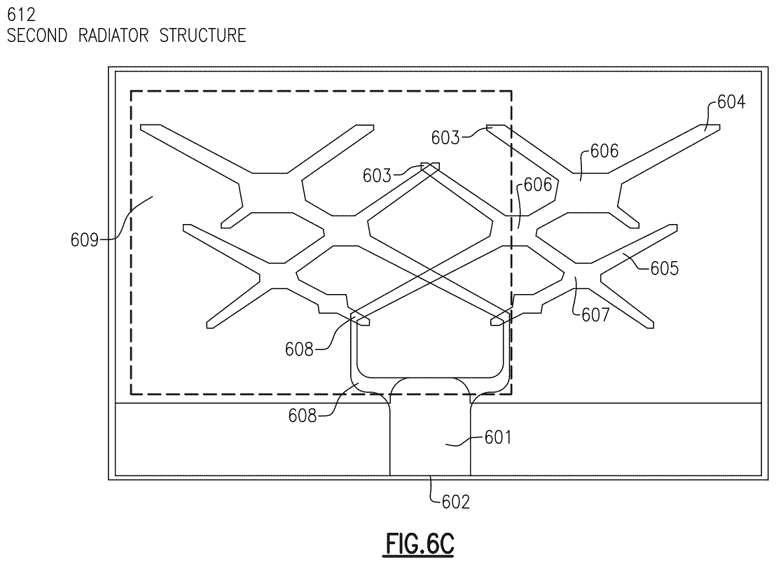

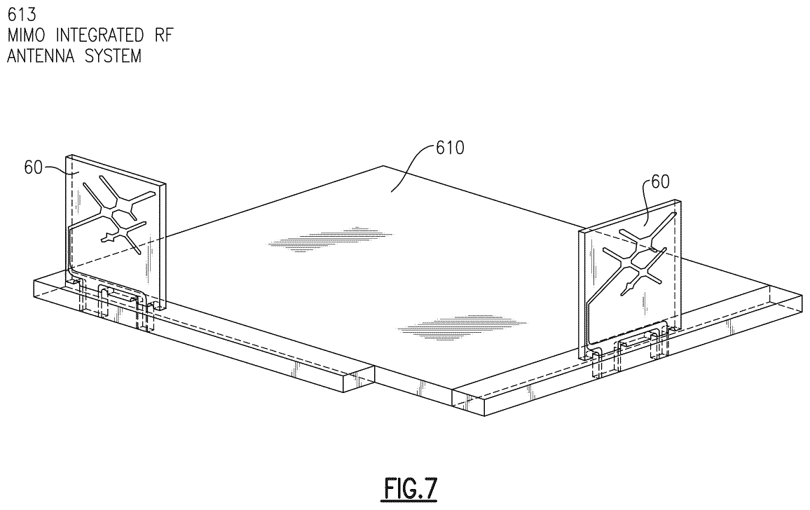

FIG. 6A illustrates a schematic block diagram of a first radiator structure in accordance to an aspect of the present invention;

FIG. 6B illustrates a schematic block diagram of a first radiator structure in a global navigation satellite system in accordance to an aspect of the present invention;

FIG. 6C illustrates a schematic block diagram of a dipole, a second radiator structure in accordance to an aspect of the present invention;

FIG. 7 illustrates a schematic block diagram of a 2×2 MIMO implementation in accordance to an aspect of the present invention;

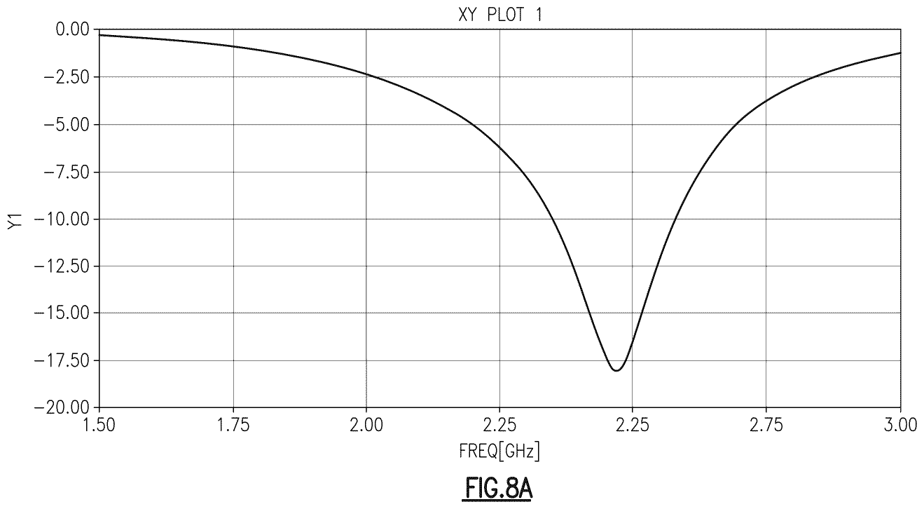

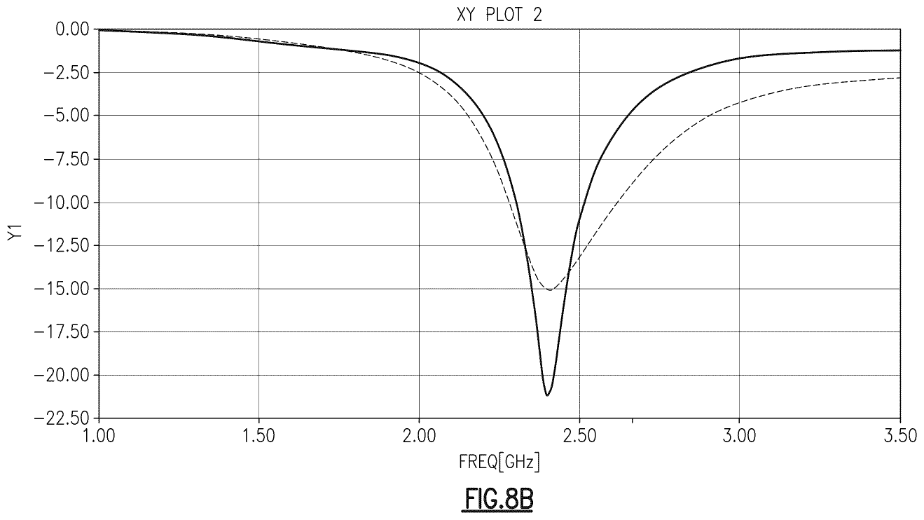

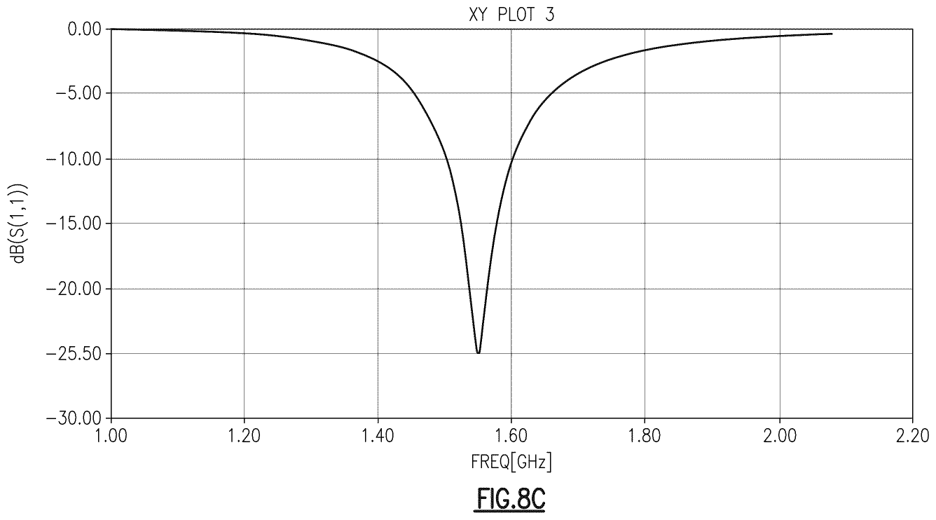

FIG. 8A-8C illustrate different diagrams illustrating the return loss of an antenna component in accordance to an aspect of the present invention.

The appended drawings are intended to provide further understanding of the embodiments of the invention. They illustrate embodiments and, in conjunction with the description, help to explain principles and concepts of the invention. Other embodiments and many of the advantages mentioned become apparent in view of the drawings. The elements in the drawings are not necessarily shown to scale.

In the drawings, like functionally equivalent and identically operating elements, features and components are provided with like reference signs in each case, unless stated otherwise.

### DETAILED DESCRIPTION OF CERTAIN EMBODIMENTS

FIG. 1 illustrates a schematic diagram of an example of a communication network.

The communication network 10 shown in FIG. 1 includes a macro cell base station 16, a small cell base station 17, and various examples of different user equipment, UE, 11-15. The user equipment 11-15 may include mobile devices 11, a wireless-connected car 12, a laptop 13, a stationary wireless device 14, and a wireless-connected train 15. Although specific examples of base stations and UEs are illustrated in FIG. 1, a communication network can include base stations and UEs of a wide variety of types and/or numbers. For instance, in the example show in FIG. 1, the communication network 10 includes the macro cell base station 16 and the small cell base station 17. The small cell base station 17 can operate with relatively lower power, shorter range, and/or with fewer concurrent users relative to the macro cell base station 16. The small cell base station 17 can also be referred to as a femtocell, a picocell, or a microcell. Although the communication network 10 is illustrated as including two base stations, the communication network 10 can be implemented to include more or fewer base stations and/or base stations of other types.

The communication network 10 of FIG. 1 can be used to support a wide variety of advanced communication features, including, but not limited to, eMBB, uRLLC, and/or mMTC.

FIG. 2A is a schematic diagram of one example of a downlink channel using multi-input and multi-output, MIMO, communications.

In the example show in FIG. 2A, downlink MIMO communications are provided by transmitting using M antenna 43a, 43b, 43e, . . . 43m of the base station 16 and receiving using N antennas 44a, 44b, 44c, . . . , 44n of the mobile device 11. Accordingly. FIG. 2A illustrates an example of MxN DL MIMO.

MIMO communication use multiple antennas for simultaneously communicating multiple data streams over common frequency spectrum. In certain implementations, the data streams operate with different reference signals to enhance data reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two, 2×2, DL MIMO refers to MIMO downlink communications using two base station antennas and two user equipment, UE, antennas. Additionally, four-by-four, 4×4, DL MIMO refers to MIMO downlink communications using four base station antennas and four UE antennas. FIG. 2B is schematic diagram of one example of an uplink channel using MIMO communications.

In the example show in FIG. 2B, uplink MIMO communications are provided by transmitting using N antennas 44a, 44b, 44c, . . . 44n of the mobile device 11 and receiving using M antennas 43a, 43b, 43c, . . . 43m of the base station 16. Accordingly, FIG. 2B illustrates an example of N×M UL MIMO.

Likewise, MIMO order for uplink communications can be described by a number of transmit antenna of UE, such as a mobile device, and a number of receive antennas of a base station. For example, 2×2 UL MIMO refers to MIMO uplink communications using two UE antenna and two base station antennas. Additionally, 4×4 UL MIMO refers to MIMO uplink communications using four UE antennas and four base station antennas.

By increasing the level or order of MIMO, bandwidth of an uplink channel and/or a downlink channel can be increased.

MIMO communications are applicable to communication links of a variety of types, such as FDD communication links and TDD communication links.

FIGS. 3A, 3B, and 3C are schematic block diagrams of front end modules with integrated antenna according to certain embodiments. An RF front end an include circuits in a signal path between an antenna and a baseband system. Some RF front ends can include circuits in signal paths between one or more antennas and a mixer configured to module a signal to RF or to demodulate an RF Signal.

FIG. 3A is a schematic block diagram of an RF front end module 80 according to an embodiment. The RF front end module 80 is configured to receive RF signals from an integrated RF antenna component 60 and to transmit RF signals by way of the integrated RF antenna component 60. The integrated RF antenna component 60 can be implemented in accordance with any of the principles and advantages discussed herein. The illustrated front end module 80 includes a first multi-throw switch 82, a second multi-throw switch 83, a receive signal path that includes an LNA 72, a bypass signal path that includes a bypass network 84, and a transmit signal path that includes a power amplifier 74. The low rose amplifier 72 can be any suitable low noise amplifier. The bypass network 84 an include any suitable network for matching and/or bypassing the receive signal path and the transmit signal path. The bypass network 84 can be implemented by a passive impedance network and/or by a conductive trace or wire. The power amplifier 74 can be implemented by any suitable power amplifier.

The LNA 72, the switches 82 and 83, and the power amplifier 74 can be shielded from the integrated RF antenna component 60 by a shielding structure in accordance with any of the principles and advantages discussed herein.

The first multi-throw switch 82 can selectively electrically connect a particular signal path to the integrated RF antenna component 60. The first multi-throw switch 82 can electrically connect the receive signal path to the integrated RF antenna component 60 in a first state, electrically connect the bypass signal path to the integrated RF antenna component 60 in a second state, and electrically connect the transmit signal to the integrated RF antenna component 60 in a third state. The integrated RF antenna component 60 can be electrically connected to the switch 82 by way of a capacitor 87. The second multi-throw switch 83 can selectively electrically connect a particular signal path to an I/O port of the front end module 80, in which the particular signal path is the same signal path electrically connected to the integrated RF antenna component 60 by way of the first multi-throw switch 82. Accordingly, second multi-throw switch 83 together with the first multi-throw switch 82 an provide a signal path between the integrated RF antenna component 60 and an I/O port of the front end module 80. A system on chip, SOC, can be electrically connected to the I/O port of the front end module 80.

The control and biasing block 86 can provide any suitable biasing and control signals to the other circuits of the front end module 80. For example, the control and biasing block 86 can provide bias signals to the LNA 72 and/or the power amplifier 74. Alternatively or additionally, the control and biasing block 86 can provide control signals to the multi-throw switches 82 and 83 to set the state of these switches.

FIG. 3B is a schematic block diagram of an RF front end module 80′ according to an embodiment. The RF front end module 80′ of FIG. 3B is similar to the RF front end module 80 of FIG. 3A, except that a transmit signal path is omitted and the mult-throw switches 82′ and 83′ each have one fewer throw than corresponding multi-throw switches in the front end module 80 of FIG. 3A. The illustrated front end module 80′ includes a receive signal path and a bypass signal path and does not include a transmit signal path.

FIG. 3C is a schematic block diagram of an RF front end module 80″ according to an embodiment. The RF front end module 80″ of FIG. 3C is like the RF front end module 80 of FIG. 3A, except that a power amplifier of the transmit signal path is omitted from the RF front end module 80″. The RF front end module 80″ includes I/O ports for coupling to throws of the multi-throw switches 82 and 83. A power amplifier external to the front end module 80″ can be electrically connected between these I/O ports such that the power amplifier is included in the transmit signal path between the multi-throw switches 82 and 83. The power amplifier can be included in a different packaged module than the illustrated elements of the RF front end module 80″.

The front end modules of FIGS. 3A, 3B, and 3C can be packaged modules. Such packaged modules can include relatively low cost laminate based front end modules that combine low noise amplifiers with power noise amplifiers and/or RF switches in certain implementations. Some such packaged modules can be multi-chip modules. In the modules of FIGS. 3A, 3B, and 3C, an antenna is integrated with the RF front end. The integrated antenna of such RF front end modules can be implemented in accordance with any of the principles and advantages discussed herein. These RF front end modules can be antenna in a package systems. The integrated antenna can be implemented in an antenna layer on a first side of a substrate that is shielded from the circuits of the RF front end on a second side of the substrate at least partly by a ground plane implemented in a layer of the substrate.

FIGS. 4A and 4B are schematic block diagrams of illustrative wireless mobile devices that include a shielded package with an integrated antenna in accordance with one or more embodiments. The wireless mobile device 90 can be any suitable wireless mobile device. For instance, wireless communication device 90 device can be a mobile phone such as a smart phone. As illustrated, the wireless mobile device 90 includes a first integrated RF antenna component 60 integrated with a wireless personal area network (WPAN) system 91, a transceiver 92, a processor 93, a memory 94, a power management block 95, a second integrated RF antenna component 96, and an RF front end system 97.

Any of the integrated antenna and shielding structures discussed herein can be implemented in connection with the WPAN system 91. The WPAN system 91 is an RF front end system configured for processing RF Signals associated with personal area networks (PANs). The WPAN System 91 can be configured to transmit and receive signals associated with one or more WPAN communication standards, such as signals associated with one or more of Bluetooth, ZigBee, Z-Wave, Wireless USB, INSTEON, IrDA, or Body Area Network. In another embodiment, a wireless communication device an include a wireless local area network (WLAN) system in place of the illustrated WPAN System. Such a WLAN System can process Wi-Fi signals or other WLAN signals. Any of the integrated antenna and shielding structures discussed herein can be integrated with the RF front end system 97.

The illustrated wireless communication device 90′ of FIG. 4B is a device configured to communicate over a WPAN. The wireless communication device 90′ can be relatively less complex than the wireless mobile device of FIG. 4A. As illustrated, the wireless mobile device 90′ includes an integrated RF antenna component 60 integrated with a WPAN system 91, a transceiver 92′, a processor 93, and a memory 94. An integrated antenna and a shielding structure can be implemented in connection with the WPAN System 91 in accordance with any of the principles and advantages discussed herein. The wireless mobile device 90′ can include a WLAN system in place of the illustrated WPAN system in another embodiment. Such a WLAN system can process WiFi signals or other WLAN signals.

FIG. 5 illustrates a schematic block diagram of an integrated RF antenna component in accordance to an aspect of the present invention. The integrated RF antenna structure 60 comprises the substrate 610, the first radiator structure 611 and an I/O port 602. The first radiator structure 611 further comprises an elongated main antenna portion 604, intersection nodes 606 and 607, one first antenna crossing portions 603 and one second antenna crossing portion 605.

The elongated main antenna portion 604 has an antenna length of one-quarter wavelength of the electromagnetic wave under the resonance frequency, which antenna length is defined by the length of the elongated main antenna portion 604 from the I/O port 602 to an open end of the elongated main antenna portion 604. Further, the first antenna radiator structure 611 comprises one first antenna crossing portion 603 which is intersecting the elongated main antenna portion 604 at a first intersection nodes 606, and one second antenna crossing portion 605 which is intersecting the first antenna crossing portion 603 at a second intersection node 607.

FIGS. 6A, 6B illustrate the schematic block diagrams of a first radiator structure in accordance to different configurations. These figures illustrate the different shape examples of a top view of the first radiator structure 611. The antenna can be used in different scenarios. For example, the first radiator structure 611 with a #-like shape is shown in FIG. 6A. The 604 is an elongated main antenna portion comprising two inflection points 608 having an antenna length of one-quarter wavelength of the electromagnetic wave under the resonance frequency, which antenna length is defined by the length of the elongated main antenna portion 604 from the I/O port 602 to an open end of the elongated main antenna portion 604. Further, the integrated RF antenna component comprises two first antenna crossing portions 603 which is intersecting the elongated main antenna portion 604 at two first intersection nodes 606, and one second antenna crossing portion 605 which is intersecting one of the first antenna crossing portion 603 at a second intersection node 607. Additionally, the antenna component comprises a feed line portion 601 connected to the I/O port 602 and short end 603 connected to the ground plane.

As another example of the first radiator structure configuration shown as FIG. 6B. The first radiator structure of the integrated RF antenna component can be operated in a global navigation satellite system, GNSS. Preferably, the GNSS device is operable based on the global positioning, GPS standard. However, it is also possible that the GNSS device is operating based on other positioning standards, such as GLONASS, Galileo and BeiDou navigation satellite system.

FIG. 6C illustrates a schematic block diagram of a dipole, a second radiator structure in accordance to an aspect of the present invention.

The integrated RF antenna component further comprises a ground plane coupled to the first radiator structure. The ground plane is configured to provide a reference potential of the integrated RF antenna structure and a mirror image 609 of the first radiator structure. The first radiator structure and the mirror image 609 of the first radiator structure defines a second radiator structure. The first radiator structure is directly attached to the first surface of the substrate. The ground plane with the mirror image 609 of the first radiator structure is directly attached to the second surface of the substrate opposite to its first surface. The first radiator structure is electrically coupled to the ground plane with the mirror image 609 of the first radiator structure. Therefore, the first radiator structure and the ground plane with the mirror image 609 of the first radiator structure form a second radiator structure which gives the complete integrated RF antenna component, a dipole antenna structure.

The MIMO integrated RF antenna system 613 is shown in FIG. 7. This configuration is a 2×2 MIMO that comprises two integrated RF antenna system 60 and one structure 610.

This configuration is primarily used in internet of things, IoT, network or smart home network. The operating resonance frequency can be 2.4 GHz or 5 GHz. The antenna component can be easily integrated in the front end device 80, 80′ and 80″. The 2×2 MIMO implementation can be configured to transmit and/or receive RF signals associated with a Wireless Personal Area Network, WPAN, standard. The 2×2 MIMO implementation of the antenna component can be configured to transmit and/or receive RF signals associated with a Bluetooth standard. The 2×2 MIMO implementation of the antenna component can be configured to transmit and/or receive RF signals associated with a ZigBee standard. The implemented architecture can be easily scaled to 4×4 system.

FIG. 8A show graph of return loss of the antenna component according to the configuration of a single integrated RF antenna component operating at resonance frequency of 2.4 GHz.

FIG. 8B show graph of return loss of the antenna component according to the configuration of FIG. 7.

FIG. 8C shows graph of return loss of the antenna component according to the configuration of a single integrated RF antenna component operating at resonance frequency of 1.5 GHZ.

Some of the embodiments described above have provided examples in connection with RF components, front end modules and/or wireless communications devices. However, the principles and advantages of the embodiments can be used for any other systems or apparats that could benefit from any of the circuits described herein. Although described in the context of RF circuits, one or more features described herein can also be utilized in packaging applications involving non-RF components. Similarly, one or more features described herein can also be utilized in packaging applications without the electromagnetic isolation functionality. Any of the principles and advantages of the embodiments discussed can be used in any other systems or apparatus that could benefit from the antenna and/or the shielding structures discussed herein.

Unless the context clearly requires otherwise, throughout the description and the claims, the words “comprise,” “comprising,” “include,” “including” and the like are to be constructed in an inclusive sense, as opposed to an exclusive or exhaustive sense; that is to say, in the sense of “including, but not limited to.” The Word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, fall refer to this application as a whole and not to any particular portions of this application. Where the context permits, words in the above detailed description of certain embodiments using the singular or plural number may also include the plural or Singular number, respectively. The word “or” in reference to a list of two or more items, hat word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or whether these features, elements and/or states are included or are to be performed in any particular embodiment.

While certain embodiments have been described, these embodiments have been presented by Way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and same blocks may be deleted, moved, added, subdivided, combined, and/or modified. Each of these blocks may be implemented in a variety of different ways.

Any suitable combination of the elements and acts of the various embodiments described above can be combined to provide further embodiments. The accompanying claims and their equivalents are intended to cover such forms or modifications as would fall within the scope and spirit of the disclosure.

What is claimed is:

1. An integrated radio frequency antenna component comprising:
a substrate having a first surface and a second surface opposite the first surface;
an I/O port configured to transmit and receive radio frequency signals;
a first radiator structure defined by a conductive material coupled to the first surface and including an elongated main antenna portion connected to the I/O port and having an antenna length of one-quarter wavelength of an electromagnetic wave under a resonance frequency, at least one first antenna crossing portion that intersects the elongated main antenna portion at a first intersection node, and at least one second antenna crossing portion that intersects the at least one first antenna crossing portion at a second intersection node; and
a ground plane coupled to the second surface and to the first radiator structure, the ground plane having attached thereto a mirror image of the first radiator structure, the first radiator structure and the mirror image forming a dipole antenna.

2. The integrated radio frequency antenna component of claim 1 wherein the first radiator structure has a #-like shape.

3. The integrated radio frequency antenna component of claim 2 wherein the first radiator structure comprises a feed line portion connected to the I/O port and an antenna portion connected to the feed line portion wherein the antenna portion comprises the #-like shape.

4. The integrated radio frequency antenna component of claim 1 wherein the first radiator structure is at least partially embedded in the substrate.

5. The integrated radio frequency antenna component of claim 1 wherein the elongated main antenna portion includes at least one inflection point between the I/O port and an open end of the elongated main antenna portion.

6. The integrated radio frequency antenna component of claim 1 wherein the at least one first antenna crossing portion intersects the elongated main antenna portion in an oblique manner.

7. The integrated radio frequency antenna component of claim 1 wherein the at least one first antenna crossing portion intersects the elongated main antenna portion in a perpendicular manner.

8. The integrated radio frequency antenna component of claim 1 wherein the at least one second antenna crossing portion intersects the at least one first antenna crossing portion in an oblique manner.

9. The integrated radio frequency antenna component of claim 1 wherein the at least one second antenna crossing portion intersects the at least one first antenna crossing portion in a perpendicular manner.

10. The integrated radio frequency antenna component of claim 1 wherein the first radiator structure has a #-like shape, and an angle between the at least one first antenna crossing portion and the elongated main antenna portion at the first intersection node is the same as an angle between the at least one second antenna crossing portion and the at least one first antenna crossing portion at the second intersection node.

11. The integrated radio frequency antenna component of claim 1 further comprising a matching network which is connected to the I/O port and which is configured to conduct impedance transformation to maximize power transfer at an operating frequency range.

12. The integrated radio frequency antenna component of claim 1 wherein the substrate consists of an electrically isolating substrate material.

13. A radio frequency module comprising:
a printed circuit board;
a radio frequency antenna component arranged on the printed circuit board and including: a substrate having a first surface and a second surface opposite the first surface; and a first radiator structure defined by a conductive material coupled to the first surface and including an elongated main antenna portion and having an antenna length of one-quarter wavelength of an electromagnetic wave under a resonance frequency, at least one first antenna crossing portion that intersects the elongated main antenna portion at a first intersection node, and at least one second antenna crossing portion that intersects the at least one first antenna crossing portion at a second intersection node; and a ground plane coupled to the second surface and to the first radiator structure, the ground plane having attached thereto a mirror image of the first radiator structure, the first radiator structure and the mirror image forming a dipole antenna.

14. The radio frequency module of claim 13 wherein the first radiator structure has a #-like shape.

15. The radio frequency module of claim 14 wherein the first radiator structure comprises a feed line portion connected to an I/O port of the radio frequency antenna component, and an antenna portion connected to the feed line portion wherein the antenna portion comprises the #-like shape.

16. The radio frequency module of claim 15 wherein the elongated main antenna portion includes at least one inflection point between the I/O port and an open end of the elongated main antenna portion.

17. The radio frequency module of claim 13 wherein the first radiator structure is at least partially embedded in the substrate.

18. The radio frequency module of claim 13 wherein the at least one first antenna crossing portion intersects the elongated main antenna portion in an oblique manner.

19. A wireless mobile device comprising:
a housing;
a processing device; and
a radio frequency module arranged in the housing, the radio frequency module including a radio frequency antenna component including: a substrate having a first surface and a second surface opposite the first surface; and a first radiator structure defined by a conductive material coupled to the first surface and including an elongated main antenna portion and having an antenna length of one-quarter wavelength of an electromagnetic wave under a resonance frequency, at least one first antenna crossing portion that intersects the elongated main antenna portion at a first intersection node, and at least one second antenna crossing portion that intersects the at least one first antenna crossing portion at a second intersection node; and a ground plane coupled to the second surface and to the first radiator structure, the ground plane having attached thereto a mirror image of the first radiator structure, the first radiator structure and the mirror image forming a dipole antenna.

20. The wireless mobile device of claim 19 further comprising at least one screen arranged in the housing and wherein the processing device includes at least one of a central processing unit (CPU), a memory, and a motherboard.
